(19) United States
(12) Patent Application Publication
(10) Pub. No.: US 2020/0045946 A1
(43) Pub. Date: Feb. 13, 2020

(54) FISHING HOOK BALLAST WEIGHT

(71) Applicant: Erika Fischer, Weilheim (DE)

(72) Inventor: Erika Fischer, Weilheim (DE)

(21) Appl. No.: 16/500,551

(22) PCT Filed: Apr. 6, 2018
(86) PCT No.: PCT/EP2018/058904

§ 371 Date: Oct. 3, 2019

(30) Foreign Application Priority Data
Apr. 10, 2017 (DE) 10 2017 107 611.5

(51) Int. Cl. A01K 95/00

(52) U.S. Cl. CPC A01K 95/005

(57) ABSTRACT

A fishing hook ballast weight comprising a ceramic material, preferably having a density of greater than 3 g/cm³. The ballast weight can be provided with attachment means, such as metal or plastic eyelets, or can include one or more through-holes for fixedly securing hooks and eye-lets or for threading a line.

The invention relates to a ballast weight for weighing down a fishing hook, to a fishing hook comprising such a ballast weight, and to ballast weights having eyelets for weighing down a fishing line.

It is known from DE 20 2010 014 743 U1, for example, to weigh down fishing hooks using lead. Moreover, DE 295 17 388 U1 discloses a steel pipe serving as a ballast weight, which is filled with lead shot or other materials.

Ballast weights are lost on occasion during angling. This results in a considerable deposition of lead in bodies of water, which must be objected to for environmental protection reasons. On the other hand, the ballast weights have to be relatively heavy, while having a small volume, to fulfill the function thereof. As a result, previously it has not been possible to show alternatives to ballast weights made of lead.

It is the object of the invention to create a fishing hook ballast weight that, when lost, is ecologically safe.

This object is achieved by the fishing hook ballast weight according to the invention made of a ceramic material.

Ceramic is inert under normal environmental conditions. Ceramic is made of chemically inactive compounds, that is, compounds that react little or not at all under environmental conditions, or of compounds that typically occur in the environment anyhow. The ceramic material preferably comprises one or more of the following compounds: aluminum oxide, zirconium oxide, barium oxide, silicon oxide, aluminum titanate, iron oxide, magnesium oxide and other oxides. In addition to oxides, nitrides and carbides or other ecologically safe substances, such as rock dust of, in particular, metamorphic rocks, such as granite, gneiss, basalt or porphyry, may also be an integral part of the ceramic.

To produce the ballast weights in a suitable mixture, the starting materials are provided in powder form, pressed and sintered, whereby the fishing hook ballast weight is created in the desired shape. Preferably, the ballast weight has a simple geometric basic shape, such as a plate shape having a round or polygonal contour, a spherical or cylindrical shape having flat or curved base and top surfaces, a prism having flat or curved base and top surfaces, a pyramid, a cone, a drop shape or the like.

The ceramic body can already be provided with additional structures or shapes during production or after sintering (firing), so as to enable attachment to wires, hooks, eyelets, lines or the like. For example, an approximately cylindrical ceramic body can be provided with a radially and longitudinally extending slot into which hooks or eyelets are glued using a plastic material, such as an adhesive, a casting resin or the like. It is also possible to use plastic clamps, hooks, dowels or the like for attachment. As an alternative, attachment elements can be provided on an outer surface of the ceramic body, for example, plastic holders by way of adhesive bonding.

The ceramic body of the ballast weight is preferably free of pores. In this way, high compression is achieved prior to sintering. Preferably, the ceramic is subjected to an isostatic pressing operation prior to sintering. The ceramic is then an isostatically pressed sintered ceramic.

The ceramic body preferably has a density of greater than 3 g/cm³, better greater than 4 g/cm³ and, in the best case, greater than 5 g/cm³. The ceramic is preferably made of aluminum oxide and/or zirconium oxide. The zirconium oxide content preferably exceeds the content of other admixtures and substances.

The fishing hook ballast weight is preferably formed by a convexly curved body. The body may include a prismatic or cylindrical section, uneven or curved top surfaces. Structures for attaching hooks, wires or other elements can be formed by slots, blind holes, through-holes or the like. The joint between parts to be connected, such as hooks, wires, eyelets or the like, and the ceramic material can be established by way of form fit, integral bond or force fit. Preferably, a casting compound, such as a synthetic resin, an adhesive or the like, is utilized for attachment.

Ballast bodies can be provided in the form of a set. Each set then comprises one or more pieces of ballast bodies having differing weights. The respective weight can be identified by a color marking, by the outer size of the ballast body, by different shapes or by an appropriate legible imprint. The imprint can be designed as a relief on the ballast body.

Details of advantageous embodiments of the invention can be derived from the drawings, the description or the claims. In the drawings:

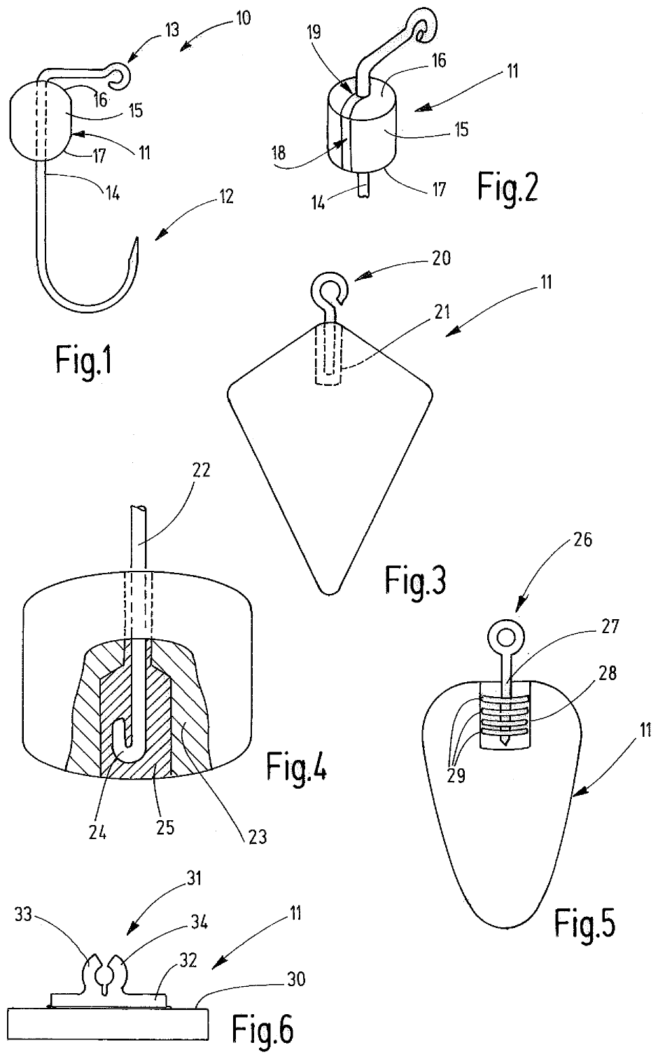

FIG. 1 shows a fishing hook including a ballast weight;

FIG. 2 shows the fishing hook according to FIG. 1 in a perspective partial view;

FIG. 3 shows another embodiment of a fishing hook ballast weight in a schematic side view; and

FIGS. 4 to 6 show further embodiments of fishing hook ballast weights in schematic illustrations.

FIG. 1 illustrates a fishing hook 10 having a fishing hook ballast weight 11 attached thereto. The fishing hook 10 includes a U-shaped curved hook section 12 and an eyelet 13 for attaching a line. The fishing hook ballast weight 11 is arranged, for example, on a straight section 14 of the fishing hook 10 adjoining the eyelet 13. The fishing hook ballast weight 11 is made of ceramic. The fishing hook ballast weight is shown separately in FIG. 2. As is apparent, this is formed by a body that is convex on the entire surface thereof and that includes a cylindrical section 15 having a curved top surface 16 and an opposing curved base surface 17. A slot 18 can be provided axially and radially, which extends through the fishing hook ballast weight 11 up to the middle or slightly further. This slot 18 can already have been provided when the ceramic body was produced in the pressed form thereof. Preferably, however, the slot is introduced into the ceramic body by cutting, such as grinding, after sintering. In this way, high dimensional precision of the slot 18 can be ensured, so that the section 14 of the fishing hook 10 is held in the slot by spring action, for example. In addition, plastic material 19, such as a casting resin, can be introduced in the slot 18 to secure the section 14 in the slot 18.

The ceramic is preferably an oxide ceramic, and preferably an oxide ceramic including aluminum oxide. The ceramic can comprise further components to increase the density, for example barium compounds, such as barium oxide, zirconium compounds or mixtures thereof. This is preferably a ceramic that is initially produced from appropriate powders by way of isostatic pressing, followed by sintering. The shape of the ceramic body can vary. Instead of the cylindrical section 15, a prismatic section having rounded corners and edges or a cube shape or the like may be provided.

FIG. 3 shows a further exemplary embodiment of a fishing hook ballast weight 11. This is provided with a line eyelet 20 made of plastic or metal, through which a fishing line can run. The fishing hook ballast weight 11 is suitable, for example, as a base weight for fixing a line on the bottom of a body of water. The fishing hook ballast weight can weigh several 10 to more than 100 grams. The line eyelet 20 can be fixed in a suitable opening of the fishing hook ballast weight 11. Such an opening 21 can have any suitable shape, for example, also the shape of a blind hole. The line eyelet 20 can be glued into this blind hole.

Other attachment options can be derived from FIG. 4 or FIG. 5, for example. In FIG. 4, a through-hole 23, which can be stepped, is provided for attaching another element 22, for example a line eyelet. The element 22 is a wire or another element, for example. The element can include a bent section 24 or another structural feature, which facilitates the anchoring of the element 22 in the through-hole 23. For example, a casting compound 25 or an adhesive or the like can be provided for anchoring.

FIG. 5 illustrates the anchoring of an eyelet 26 with a plastic shaft 27 in a blind hole 28 of the fishing hook ballast weight 11, which can be designed in the shape of an egg here, for example. However, it can also have another shape. One or more radially projecting fingers or disks 29 can be provided on the shaft 27, having diameters that are slightly larger than the diameter of the blind hole 28. When the plastic shaft 27 is pushed into the blind hole 28, the edges of the disks 29 brace against the wall of the blind hole 28, thereby bringing about mechanical wedging.

Other embodiments of the fishing hook ballast weight 11 are based on the basic shape of a plate. FIG. 6 shows such an exemplary embodiment. The plate-shaped body can have a circular contour and thus form a flat cylinder. The body can also be designed polygonally having sharp or rounded edges, for example as a triangular plate, a quadrangular plate or the like. In any case, the body has a surface area 30 that is designed as a planar surface area, for example. This surface area 30 can serve as a mounting surface for an attachment element 31, which is preferably made of a plastic material. It can include a plate-like foot 32, which is adhesively bonded to the surface area 30 or molded thereon and thus, in any case, is integrally joined thereto. Attachment structures, such as an eyelet or the like, can project from the foot 32. For example, the attachment structure can be formed by spring-loaded legs 33, 34, between which a line, a wire section or the line can be clamped.

The advantage of the fishing hook ballast weight 11 according to the invention is the non-toxic nature and physiological safety of the material thereof. Should such a ballast weight be lost in a body of water, this does not even pose an environmental hazard if lost frequently and on a larger scale.

A fishing hook ballast weight according to the invention is made of a ceramic material, preferably having a density of greater than 3 g/cm³. The ballast weight can be provided with attachment means, such as metal or plastic eyelets, or can include one or more through-holes for fixedly securing hooks and eyelets or for threading a line.

### LIST OF REFERENCE NUMERALS

10 fishing hook
11 fishing hook ballast weight
12 hook section
13 eyelet
14 section
15 cylindrical section
16 top surface
17 base
18 slot
19 plastic material
20 line eyelet
21 opening
22 element
23 through-hole
24 section
25 casting compound
26 eyelet
27 plastic shaft
28 blind hole
29 disks
30 surface area
31 attachment element
32 foot
33, 34 legs

1. A fishing hook ballast weight comprising a ceramic material.

2. The fishing hook ballast weight according to claim 1, wherein the ceramic material has a density of greater than 3 g/cm³.

3. The fishing hook ballast weight according to claim 1, wherein the ceramic material is produced from a powdery starting material, which was first subjected to an isostatic pressing operation so as to generate a highly compressed green body, which was then fed to a sintering operation.

4. The fishing hook ballast weight according to claim 1, wherein the ceramic material preferably comprises one or more compounds selected from the following groups: aluminum oxide, zirconium oxide, barium oxide, silicon oxide, aluminum titanate, iron oxide, magnesium oxide, other metal oxides, nitrides, carbides, rock dust of metamorphic rocks, such as granite, gneiss, basalt or porphyry.

5. The fishing hook ballast weight according to claim 1 further comprising a cylindrical section or a prismatic section.

6. The fishing hook ballast weight according to claim 1, further comprising at least one spherically curved surface.

7. The fishing hook ballast weight according to claim 1, further comprising a slot for receiving a plastic or metal element.

8. The fishing hook ballast weight according to claim 1, further comprising a hole for receiving a plastic or metal element.

9. The fishing hook ballast weight according to claim 1, further comprising a blind hole for receiving an attachment element.

10. The fishing hook ballast weight according to claim 1, wherein a connecting element made of a different material is associated therewith, by way of which a line is attached or mounted.

11. The fishing hook ballast weight according to claim 10, wherein the connecting element is made of a plastic material.
